(19) United States
(12) Patent Application Publication
(10) Pub. No.: US 2024/0346470 A1
(43) Pub. Date: Oct. 17, 2024

(54) Computer Implemented Method For Dynamically Settling Payment Requests with Various Funding Sources Computer Implemented Method For Dynamically Settling Payment Requests with Various Funding Sources

(71) Applicants: IncumbentFI, Inc., Vancouver (CA); BANGOR BANKCORP MHC, Bangor, ME (US)

(72) Inventors: James B. Doughty, Bangor, ME (US); Scott S. Blake, Bangor, ME (US)

(21) Appl. No.: 18/580,300

(22) PCT Filed: Jan. 6, 2023
(86) PCT No.: PCT/US23/10296

§ 371 Date: Jan. 18, 2024

Related U.S. Application Data
(60) Provisional application No. 63/297,081, filed on Jan. 6, 2022.

(51) Int. Cl. G06Q 20/10; G06Q 20/22

(52) U.S. Cl. CPC G06Q 20/102; G06Q 20/22

(57) ABSTRACT

A computer implemented system and method for dynamically settling an electronic funding request using multiple funding sources that may include conventional accounts such as checking as credit accounts as well as accounts that are associated with reward programs and other third-party programs

### BACKGROUND INFORMATION

### Field of the Invention

The invention relates to computer-implemented systems and methods for settling payment card transactions.

### Discussion of Prior Art

Electronic payments are performed and processed in a variety of manners using various payment devices such as payment cards having a magnetic strip that is swiped in a magnetic reader of the payment terminal, or a payment computer chip that is inserted into a corresponding chip-reading slot of the payment terminal, and/or near field communication (“NFC”) enabled devices such as a smartphone or smartwatch that is tapped at or near the payment terminal and subsequently transmits payment information over a secure wireless connection. Techniques also exist for using payment cards without the card being physically present at the point of sale. The forms of the various payment cards also varies and includes such things as credit cards, debit cards, and automated teller machine (“ATM”) cards. These payment cards are typically linked to one and only one funding source, generally a checking, savings, or credit account.

In general, the payment terminal receives payment information from the payment device as well as information about a transaction, and communicates this information directly to a payment system for processing of the transaction. Following is a common example for processing a debit card payment: 1) a customer submits a debit card for payment by inserting, tapping, or swiping a card at a merchant's payment terminal, or the card's data is otherwise read into a payment terminal, which is a point-of-sale system (“POS”); 2) the POS reads the card information and communicates with an Acquirer, who transmits the data to the customer's card processing network, such as Visa or MasterCard (this is often referred to as the “4-party model”, which includes the Acquirer, the Issuing Bank, the Card Scheme (e.g. Visa), and the Gateway or network); 3) the card processing network verifies the data and then sends the data to an issuing bank; 4) the issuing bank confirms that enough funds are available to satisfy the payment and approves said transaction or if sufficient funds are not available, it denies the transaction; 5) if the transaction is approved, the card processing network settles the transaction with the merchant.

Again, in general terms, standard messaging protocols are used to facilitate these transactions. For example, International Organization for Standardization (“ISO”) 8583 is an international standard for financial-transaction-card-originated interchange messaging. Specifically, it is the International Organization for Standardization of standards for systems that exchange electronic transactions initiated by cardholders using payment cards. ISO 8583 defines a message format and a communication flow so that different systems can exchange these transaction requests and responses. The vast majority of transactions made when a customer uses a card to make a payment in a store, such as at an Electronic Funds Transfer at Point of Sale (“EFTPOS”) terminal, use ISO 8583 at some point in the communication chain, as do transactions made at ATMs. In particular, the MasterCard, Visa, and Verve networks base their authorization communications on the ISO 8583 standard, as do many other institutions and networks.

As a specific example, the EPOC module from FISERV is able to accept payment cards from a user, read the data and transmit said data to a processing network provided by INTERPRO TECHNOLOGY which in turn passes the data to a card processor provided by JACK HENRY & ASSOCIATES, INC. to settle the transactions.

Separate from these conventional payment transaction models, many financial institutions also have so-called reward programs, which are often referred to as “point programs”, whereby a cardholder receives rewards, or “points”, for certain activities that are usually related to spending. For example, certain credit cards offer a certain percentage of a user's purchases as a “cash back” incentive to use the card, such as 1.5% “back” on every dollar spent. Additionally, certain debit card programs offer “points” that may be applied towards future purchases.

One common element with these reward programs is that they all occur after-the-fact, meaning that rewards are earned and redeemed sometime following the transaction and in a completely unrelated manner. With the “cash back” example above, it is common for rewards to be generated after a billing period closes or a payment is made. Subsequent to the grant of the “rewards”, the cardholder is able to make an unrelated and standalone decision as to what to do with the rewards, such as having “cash” applied to an outstanding balance.

These existing reward programs, however, do not allow for the application of rewards at the time of a transaction; they are all effectively backend, after-the-fact applications. Additionally, while these various payment processing and reward programs work well on their own, attempting to capture the benefits of multiple programs is time consuming and cumbersome.

What is needed, therefore, is a computer-implemented system for the real-time application of reward points whereby accrued points may be applied to the transaction at the point-of-sale. What is still further needed is an automated manner of breaking the one-to-one correspondence of the payment card to the payment account such that cardholders may capture any rewards that may be available to satisfy the requested payment and/or redirect the funding of the transaction to one or more additional funding sources, all without disrupting the normal flow of transactions or requiring the participation of anyone other than the issuing bank and the cardholder.

### BRIEF SUMMARY OF THE INVENTION

The invention is a computer-implemented system and method for dynamically settling electronic payment requests with multiple funding sources; it is a real-time intersection of a payment request and the application of a business model that enables users to choose and apply varying types of funds. In so doing, the invention provides the ability to intercept and add business value to a payment card transaction in a manner that is transparent to the existing structure.

The system and method operates between a traditional front-end processor that accepts electronic payment cards, such as debit or credit cards, and one or more backend funding sources. The one or more backend funding sources may include a conventional source, such as a bank account or credit card settlement source from the card issuing institution, as well as various reward programs. More specifically, the system and method enables the real-time application of multiple backend funding sources to a payment card transaction at the point of sale. If, for example, one of the backend funding sources is a so-called “reward program”, the system and method is able to settle the transaction with previously accrued points applied to said transaction and any newly accrued rewards are made available for application to subsequent transactions.

Based on the prior example, upon receiving a payment request, the system and method processes the request to determine whether the payment card and the merchant both participate in one or more matching reward programs. If there is a match, the system proceeds to request funding from the reward program. If there is sufficient funding from a reward program those reward funds are applied to settle the transactions. However, if there are insufficient funds, additional reward programs may be accessed and/or a conventional funding source, such as a checking account, may be used.

A graphical user interface is also provided, likely in the form of a smart phone application (an “App”), which enables a user to configure and control various funding sources that fund the backend of the overarching payment system.

### BRIEF DESCRIPTION OF THE DRAWINGS

The present invention is described with reference to the accompanying drawings. In the drawings, like reference numbers indicate identical or functionally similar elements. The drawings are not drawn to scale.

FIG. 1 illustrates the overall architecture of the system.

FIG. 2 illustrates a specific example of the system architecture that includes an issuing bank and one reward program.

FIG. 3 illustrates an example of request filter processing.

FIG. 4 illustrates an example of a partial funding scenario.

FIG. 5 illustrates a message queuing example.

FIG. 6 illustrates a TCP/IP socket interface.

FIG. 7 illustrates an example of a user interface

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

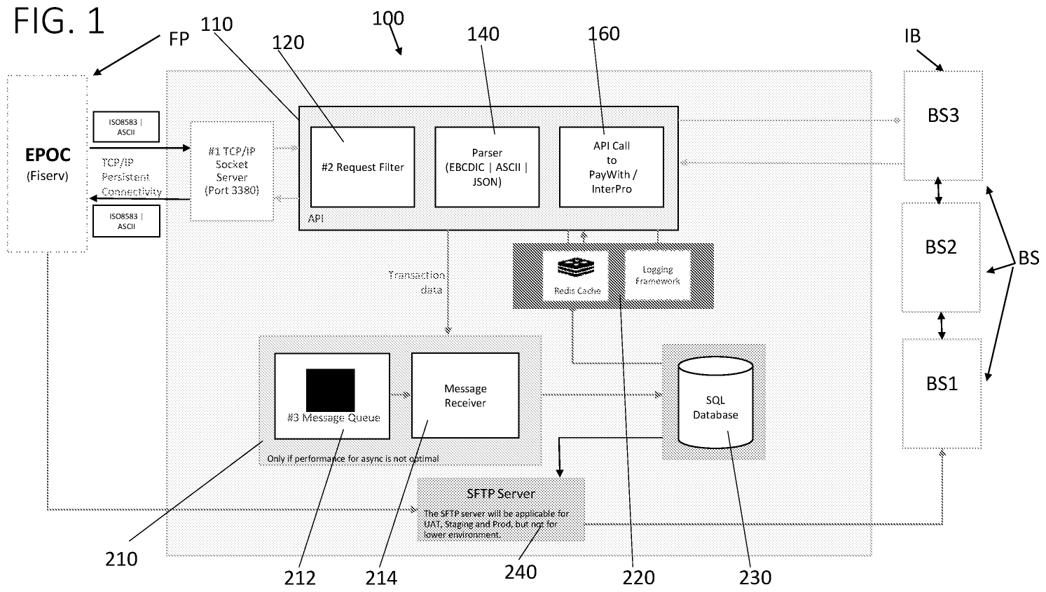

FIG. 1 illustrates a computer-implemented system and method for dynamic processing of electronic payment settlement from various funding sources 100 according to the invention. The dynamic system and method 100 operates between a frontend payment processor FP and a number of backend funding sources BS to dynamically identify and allocate funding solutions from a number of sources, including various bank accounts and reward programs, in real-time.

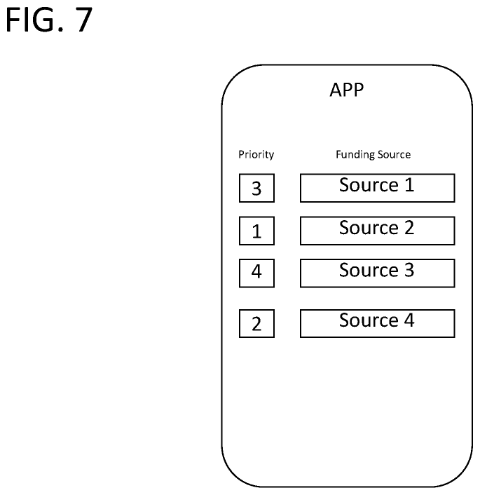

The frontend payment processor FP likely includes a conventional electronic funds transfer (“EFT”) system, such as an EFT at Point of Sale (“EFTPOS”) terminal, and one or more computing devices that has a processor and a graphical user interface (“GUI”). In the illustrations, the specific EFTPOS is an EPOC that is provided by FISERV. The EFT and computing devices are able to receive user input, for example payment card information from a card holder that is either entered into the EFT, the GUI, or retrieved from a data source, and subsequently transmit and receive data via the data source. A separate system with a graphical user interface is likely provided, likely in the form of a smart phone application (an “App”) as illustrated in FIG. 7, in order to enable a user to configure and control various funding sources that may be available to settle payment transactions for a given card at a given merchant. Conventional programming methods are used to implement the system and method and may be accomplished in a variety of manners using such conventional software development techniques.

The backend funding sources BS may include, but are not limited to, for example, conventional checking, savings, or credit card accounts, reward programs sponsored by the issuing bank, other third-party reward programs, buy-now-pay-later providers, or a reward program specific to the merchant that originated the transaction. An issuing bank IB that is the issuer of the card is likely to be the conventional source of funds and may also be considered a backend funding source BS.

The method 100 includes an application programming interface (“API”) 110 that includes a number of modules including a request filter 120, a parser 140, and a call module 160 that collectively process the payment request between the frontend payment processor FP and the one or more backend funding sources BS.

More specifically, the request filter 120 provides the initial processing of the payment request to determine which backend funding sources BS are available to settle the transaction, and based on that determination, sends out an appropriate transaction message for the respective funding sources. For example, the request filter 120 may be configured so that only certain cards may access certain backend funding sources BS, e.g. reward programs, for a given merchant. This may be the case, for example, when a particular merchant only selects particular reward programs in which to participate. In this instance the request filter 120 does not forward transactions from ineligible cards, e.g. reward cards the merchant does not accept, and instead sends the transaction message only to eligible backend sources which may only be the issuing bank IB account as the conventional source of settlement funds.

If there are multiple backend funding sources BS a priority may be assigned to each one using conventional programing techniques or a user interface such that the source having the highest priority is accessed first and so on through the priority list. For example, if there is a payment request for $30 and the user has $6 of reward points in one backend funding source BS account and $50 of conventional funds in an Issuing Bank IB banking account the method might settle the payment by applying the $6 from the reward account and $24 from the banking account.

The transaction message from the request filter 120 is subsequently sent to and interpreted by the parser 140 which places the transaction message in the proper format for the backend funding source BS and/or issuing bank IB. Subsequently, the call module 160 transmits the reformatted transaction message to the appropriate backend funding source.

More specifically, the filter 120 passes the request along to the parser 140, which is a software module that matches the language of the request with the language of the funding source BS or with the issuing bank IB. For example, an incoming ISO8583 message from the frontend processor FP may be converted, or parsed, into an extended binary-coded decimal interchange code (“EBCDIC”) or a JavaScript Object Notation (“JSON”). The parser 140 uses conventional programming techniques to perform the conversion and the format of the messages that are being converted are known in advance so that the appropriate conversion may be completed.

The API 110 also communicates with a messaging system 210 that includes a message queue 212 and a message receiver 214. These components use conventional programming means to moderate the flow of funding requests so that individual requests are not missed or lost due to many requests randomly being submitted at a particular time.

A conventional data cache 220 is also provided to assist processing times in a conventional manner. All message data is stored in a conventional database 230.

A conventional secure shell file transfer protocol (“SFTP) server 240 is also provided. In a conventional payment processing system, all payments made within a given timeframe are ultimately settled in a batch format at a predetermined time towards the end of a given day. The individual transactions themselves are noted on the cardholder end, but the actual institution-to-institution transfer happens at this later time. The SFTP Server 240 is the conventional mechanism for storing and batch processing the transactions at a later predetermined time. More specifically, the API 110 stores all transaction data in the database 230. The SFTP Server 240, at the specified times, pulls the data from the database 230 and, based on the previously completed real-time transactions, commences the actual payment settlements using conventional ACH channels to transfer the dedicated funds to the proper destination(s).

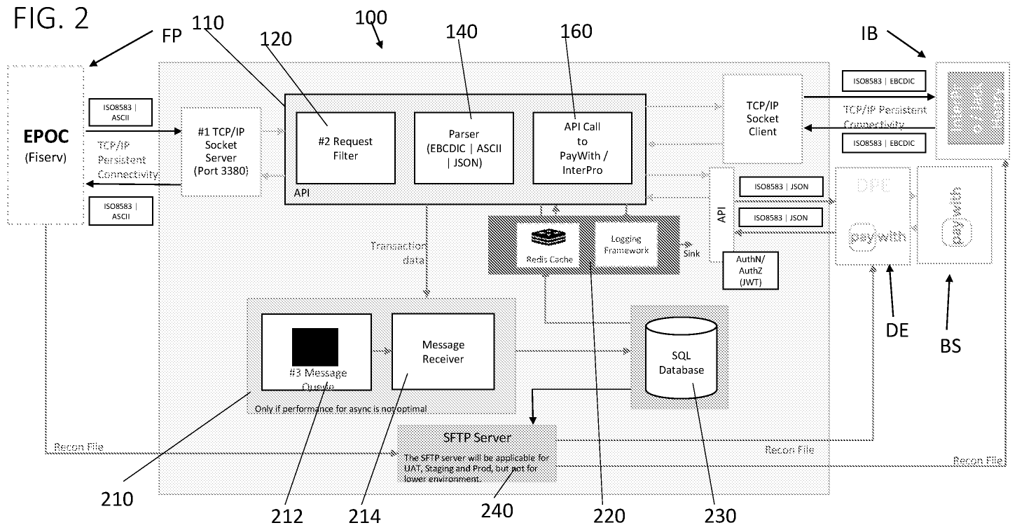

A more specific but non-limiting example is illustrated in FIGS. 2-6, where the method 100 is configured to access two backend funding sources, an issuing bank IB known as JACK HENRY and a reward program run by PAYWITH. To access the PAYWITH reward program, a transaction processing engine DE provided by PAYWITH is incorporated.

Again, the method 100 accepts a payment request from a cardholder who may be, for example, using a debit card at an EFTPOS. The EFTPOS may then process the request in the form of an ISO8583 ASCII message from, for example, FISERV's EPOC processor.

The request filter 120 again provides the initial processing of the payment request to determine whether or not a transaction is eligible for the PAYWITH reward program. If the payment request is not eligible for the program the request filter 120 does not forward the request to the transaction processing engine DE but instead sends it directly to the issuing bank IB. The transaction message is interpreted by the parser 140 and placed in the proper format for either the transaction processing engine DE or the issuing bank IB, the required formats for each known and coded into the system using conventional methods. Subsequently, the call module 160 transmits the transaction message to either the transaction processing engine DE or the issuing bank IB for settlement processing.

If the request is processed through for the PAYWITH program and the cardholder does not have sufficient funds in the backend-funding source BS, the transaction-processing engine DE returns the response to the method 100, which in turn passes on the transaction to the issuing bank IB for conventional processing. If the payment is eventually completed, a payment-complete message is sent back to the frontend payment processor FP, or if the available funding sources do not have sufficient funds, then a payment-failed message is returned to the frontend payment processor FP. Additionally, if the transaction originated from a participating merchant, the transaction-processing engine DE may award certain reward points for the transaction that are recorded in the backend funding source BS.

Once converted, the Parser 140 relays the message to the API call module 160 that interfaces with the transaction processing engine DE for participating transactions or with the issuing bank IB for the rest to ascertain what funds are available. As noted, if there are sufficient reward funds, a message is sent back through to the frontend processor FP that the transaction is complete. If there are not sufficient funds with the additional backend funding sources BS the request filter 120 sends a message to the conventional payment processor for final settlement with a conventional funding source, i.e. the Issuing Bank IB, if the account with the Issuing Bank IB has sufficient funds. If the account with the Issuing Bank also lacks the funds, a message is sent indicating that the payment could not be completed.

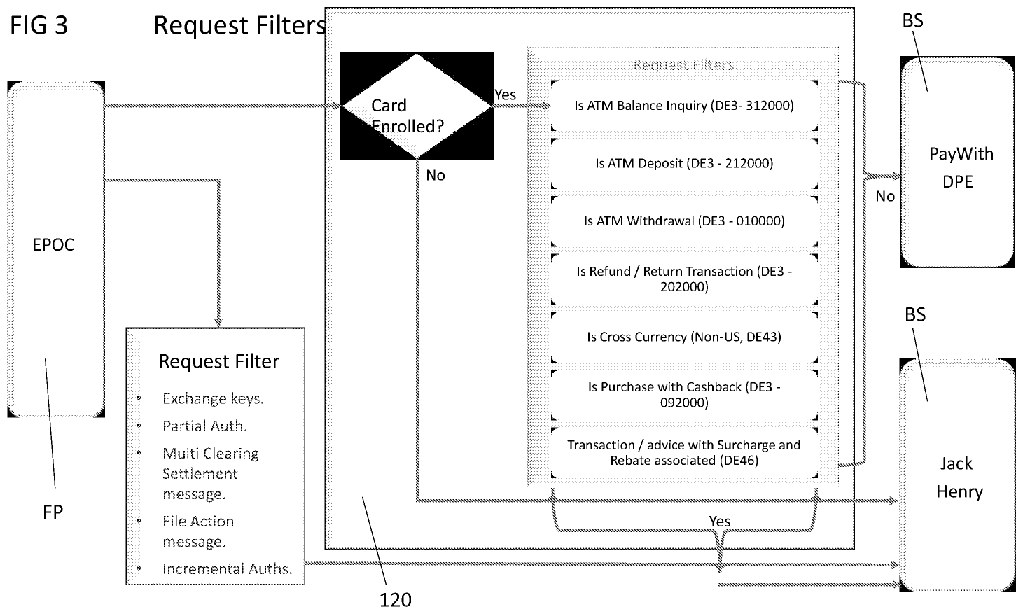

A more specific, non-limiting example of the request filter is shown in FIG. 3, wherein the filter 120 first determines whether the payment card is enrolled in a reward program, which in this example is again a particular program run by PAYWITH. In this instance, the reward program is an example of an additional backend funding source BS. If the card is not enrolled in a program, the request is simply sent on to a traditional payment processor such as JACK HENRY for settlement through, for example, a checking account. However, if the card is enrolled in a program, the filtering process continues to determine what should be done with this particular request. Again, referring to this example, the filter proceeds to determine whether the request is one of the following: 1) an automated teller machine (“ATM”) balance inquiry; 2) an ATM deposit; 3) an ATM withdrawal; 4) a refund or return transaction; 5) a cross currency transaction; 6) a cash-back purchase; 7) a transaction associated with a surcharge or rebate. If the request is any one of these, it is passed on for traditional processing. If the request is not one of these, then, as in this example, the request is a payment request and it is passed on to the reward program, as the additional backend funding source BS, for available funding from the reward program.

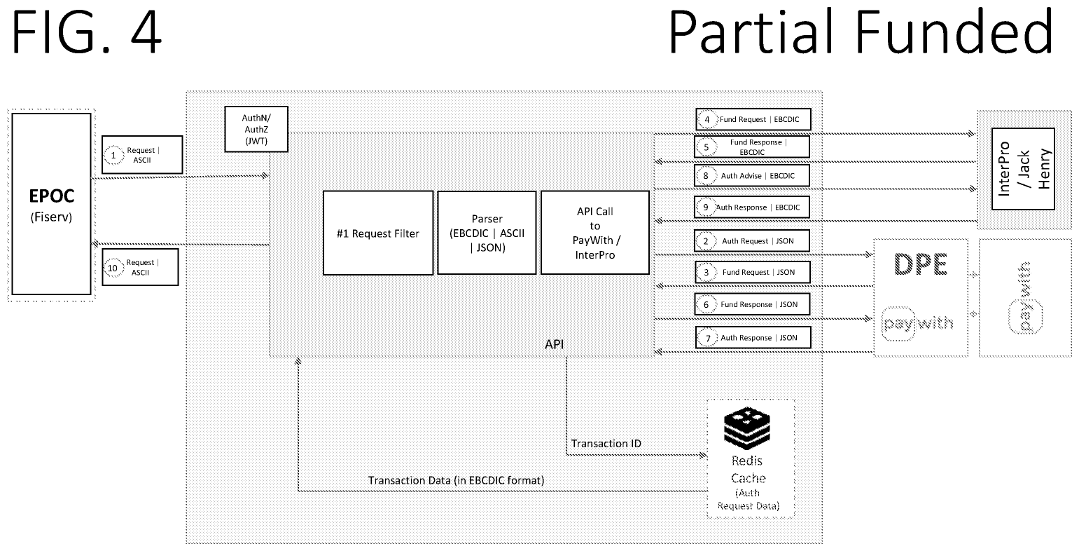

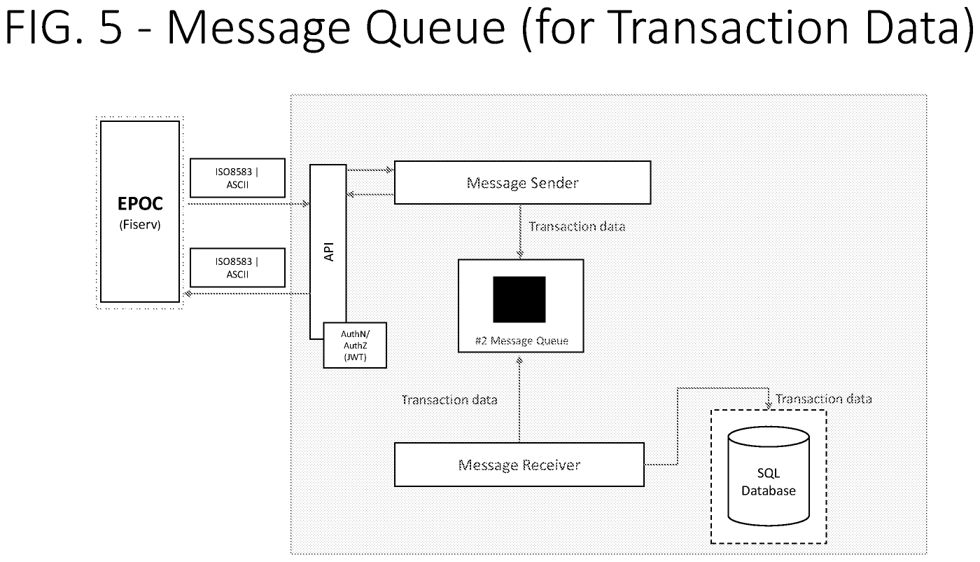

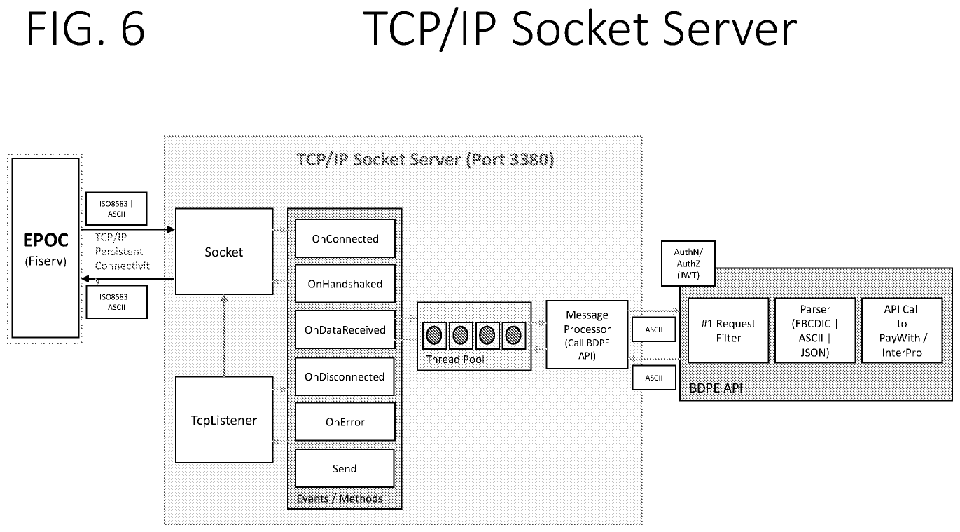

FIG. 4 illustrates messages being passed between the backend funding sources and the method when only partial funding is available for the first backend funding source. FIG. 5 illustrates a message queue for processing transaction data during a time when the request numbers are relatively high. FIG. 6 illustrates a detailed diagram of the TCP/IP socket server.

As previously mentioned, the method is a computer-implemented method that is executed on a computing device. The computing device is a conventional computer system having a conventional processor, such as a microprocessor, and having an operating system such as Microsoft Windows, Apple OS X, or a Linux distribution. The computing device may also be a mobile device such as a smart-phone, tablet, or personal digital assistant that likely uses an operating system such as iOS or DROID. The method may be implemented to run on the conventional computer system using a number of conventional programming techniques in a number of conventionally suitable programming languages. As such, the method may include computer-readable media encoded with a computer program, e.g. software, which includes instructions operable to cause the computing to perform methods of various embodiments. The software implementation, i.e., the computer-implemented method, may include microcode, assembly language code, or a higher-level language code, which further may include computer readable instructions for performing various methods. The code may form portions of computer program products. Further, the code may be tangibly stored on one or more volatile or non-volatile computer-readable media during execution or at other times. These computer-readable media may include, but are not limited to, hard disks, removable magnetic disks, removable optical disks, memory cards or sticks, random access memories, read-only memories, and other similar such technologies.

Various embodiments of the computer-implemented method implement the one or more software programs in various ways, including procedure-based techniques, component-based techniques, and/or object-oriented techniques, among others. Specific examples include C#, .NET and commercial class libraries. Those of ordinary skill in the art will appreciate that the hardware depicted herein may vary depending on the implementation. The depicted example is not meant to imply architectural limitations with respect to the present invention.

The computing device is configured to communicate with the data source using conventional means. For example, the data source may be a conventional database stored on a local hard drive or a networked hard drive, with communication carried via internal hardware or via a hardwired network. Alternatively, or in addition, the data source may also be cloud-based and communication may be carried out via a network using hardwired or wireless technologies.

If the method uses a network, that network may use any number of standard communication technologies, such as, for example, Ethernet, 802.11, 4G and/or 5G, digital subscriber lines, etc. Similarly, the network may use any number of standard communication protocols, such as, for example, transmission control protocol/internet protocol (TCP/IP), simple mail transfer protocol (SMTP), file transfer protocol (FTP), and/or the hypertext transport protocol (HTTP). The data being exchanged over the network may be represented using known technologies, such as hypertext markup language (HTML), and/or the extensible markup language (XML).

As used herein, the term “real-time” refers to at least one of the time of occurrence of the associated events, the time of measurement and collection of predetermined data, the time to process the data, and the time of a system response to the events and the environment. In the embodiments described herein, these activities and events occur substantially instantaneously.

It is understood that the embodiments described herein are merely illustrative of the present invention. Variations in the construction of the system and method may be contemplated by one skilled in the art without limiting the intended scope of the invention herein disclosed and as defined by the following claims.

What is claimed is:

1: A computer implemented method for dynamically processing electronic payments, the computer implemented method comprising the steps of:
1) receiving a payment request from a frontend payment processor at a merchant;
2) identifying, by a processor, one or more backend funding sources that are available to settle the payment, the one or more backend funding sources including an issuing bank, each of the one or more backend funding sources being added to a list of funding sources;
3) determining, by a processor, if one or more of the backend funding sources in the list of funding sources have funds available to settle the payment request;
3a) if there are one or more backend funding sources that have funds and that are not the issuing bank, determining, by a processor,
3ai) if the backend funding source has sufficient funds to settle the payment request, using the funds to settle the payment request and sending an electronic message to the frontend payment processor to notify the frontend payment processor that the payment request is complete; or
3aii) if the backend funding source does not have sufficient funds to settle the request applying the available funds to the payment request and repeating step 3; or
3b) if there are no backend funding sources that have funds and that are not the issuing bank, determining, by a processor,
3bi) if the issuing bank has sufficient funds to settle the payment request, and if the issuing bank has sufficient funds sending a message, by processor, to the frontend payment processor to notify the frontend payment processor that the payment request is complete; or
3bii) if the issuing bank does not have sufficient funds to settle the request sending a message, by processor, to the frontend payment processor that the payment request could not be completed; or
3c) if there are no backend funding sources that have funds available to settle the payment request sending a message, by processor, to the frontend payment processor that the payment request could not be completed.

2: The computer implemented method of claim 1, step 2 further including the steps of determining whether the merchant accepts any of the backend funding sources and, if it does, adding only those backend funding sources that the merchant accepts to the list of funding sources.

3: The computer implemented method of claim 2, wherein each backend funding source in the list of funding sources has a priority assigned to it and wherein step 3 of the method uses the priority to determine an order in which the backend funding sources are accessed.

4: The computer implemented method of claim 1, further including the step of:
4) determining whether the payment request is eligible for any rewards and, if it is, recording the rewards with the backend funding source that is appropriate for the rewards.

5: The computer implemented method of claim 1, wherein step 1 includes a request filter that accepts the payment request and determines which backend funding sources may be available for the payment request.

6: The computer implemented method of claim 4, wherein in step 1 the request filter passes the payment request to a parser that is configured to convert the payment request into a language that the backend funding sources accept.

7: The computer implemented method of claim 5, wherein in step 1 the parser sends the converted payment request to a call module that sends the payment request to the backend founding sources.
